(19) United States
(12) Patent Application Publication
(10) Pub. No.: US 2018/0017238 A1
(43) Pub. Date: Jan. 18, 2018

(54) HOUSING FOR LIGHTING DEVICES, CORRESPONDING LIGHTING DEVICE AND METHOD

(71) Applicant: OSRAM GmbH, Munich (DE)

(72) Inventors: Luca Volpato, Preganziol (Treviso) (IT); Roberto Didone', Rosà (Vicenza) (IT)

(21) Appl. No.: 15/641,365

(22) Filed: Jul. 5, 2017

(30) Foreign Application Priority Data
Jul. 12, 2016 (IT) 102016000072576

(51) Int. Cl. F21V 21/002; F21V 23/00

(52) U.S. Cl. CPC F21V 21/002; F21V 23/002; F21Y 2103/10; F21Y 2115/10

(57) ABSTRACT

A lighting device, e.g. a LED lighting device, includes an electrically insulating channel-shaped elongated housing, with a plurality of electrically conductive lines which extend along a length of the channel-shaped body. The electrically conductive lines are embedded in the channel-shaped body, wherein there may be arranged one or more electrically-powered light radiation source modules provided with electrical contact formations with the electrically conductive lines.

### CROSS-REFERENCE TO RELATED APPLICATION

This application claims priority to Italian Patent Application Serial No. 102016000072576, which was filed Jul. 12, 2016, and is incorporated herein by reference in its entirety.

### TECHNICAL FIELD

The description relates to lighting devices.

One or more embodiments may refer to lighting devices employing electrically-powered light radiation sources, such as solid-state sources, e.g. LED sources.

One or more embodiments may find application in the implementation of LED modules which are protected against the penetration of foreign agents, e.g. having an IP degree protection.

### BACKGROUND

Lighting devices such as LED modules, e.g. having an elongated (linear) shape and optionally being flexible, may offer a high level of flexibility as regards installation: as a matter of fact, final users may cut, from a continuous reel, strips of desired lengths according to the application and usage needs.

Desirable features in such modules are a protection against foreign agents (e.g. an IP degree protection) and/or mechanical flexibility, in order to meet different installation needs, as well as flexibility in lumen output.

In order to implement protected linear LED modules, the modules may be initially provided without protection, i.e. without sealing, and may subsequently be treated in different ways according to the protection degree to be achieved.

Exemplary possible solutions are the following:
a surface lacquering or covering (e.g. via a surface injection of protective material),
the insertion of LED modules into a protective tube,
an overall injection around the module, and/or
   the introduction of a potting mass into a protective tube.

These solutions may be disadvantageous because they may require different layout designs, e.g. when different LEDs are intended to be used and/or different LED pitches must be implemented.

Moreover, such modules may exhibit a satisfactory bendability only in one plane, e.g. perpendicular to the laminar support structure, which may be implemented e.g. as a Flexible Printed Circuit (FPC).

In addition, the ohmic resistance of the electrically conductive lines (e.g. copper lines) used for supplying the driving voltage along the LED module may impose limits on the maximum length of the LED module. These electrically conductive lines may have thicknesses limited to standard values (e.g. 35-50 μm: 1 μm=10⁻⁶ m), their width being adapted to be reduced in some points due to design constraints.

Other solutions have also been proposed based on standard flat cables, as normally used in various electrical devices, whereon there may be arranged mounting locations for LEDs and other electronic components via engravings into the insulating material, the electrical connection between the LEDs and the supply cables being achieved by uncovering the copper wires in certain dedicated areas.

In such solutions, an IP degree protection may be obtained by inserting the system into a protective tube, or covering the electronic components with protective materials.

For example, a standard flat cable may be used for the mains voltage supply, and a shrinkable sleeve may act as a protective tube. In other solutions, a standard flat cable may be used for data transmission, while the protection may be achieved through and injection/covering of protective material.

For example, document DE 102013203666 A1 describes a multi-wire flat cable, wherein the locations for LEDs and electronic components are obtained by removing insulating material.

Document U.S. Pat. No. 6,914,194 B2 describes a flat two-wire cable, wherein the locations for LEDs and electronic components are obtained by removing insulating material. The IP protection is achieved by insertion into a transparent sheath.

The main disadvantages of such solutions reside in the implementation complexity as regards manufacturing and costs connected with the production of flat cables, e.g. with CNC machines, as well as in the complexity of the mounting process of the electronic components.

### SUMMARY

One or more embodiments aim at overcoming the previously outlined drawbacks.

According to one or more embodiments, said object may be achieved thanks to a housing for lighting devices having the features set forth in the claims that follow.

One or more embodiments may also concern a corresponding lighting device, as well as a corresponding method.

The claims are an integral part of the technical teachings provided herein with reference to the embodiments of the present specification.

One or more embodiments envisage the use of profiled elements of polymeric materials (e.g. silicone or other polymers) having a channel-shaped or U-shaped profile, wherein there are integrated flexible cables or flat conductors adapted to distribute an electrical supply and/or other electrical signals (e.g. for driving the light radiation sources).

Along said profiled element it is then possible to arrange, virtually at any position, single light radiation sources, such as Printed Circuit Boards (PCBs) provided with LEDs, e.g. of the type Chip on Board (CoB) or the like.

In one or more embodiments, it is therefore possible to provide a virtually free spacing pitch of the light radiation sources, with different possible implementations as regards e.g. the establishment of the electrical contact with the conductors integrated in the housing.

One or more embodiments may achieve an IP degree protection, e.g. via a sealing or potting mass e.g. of a transparent material.

One or more embodiments may lead to the achievement of one or more of the following advantages:
for the distribution of the supply voltage along the module it is possible to use electrically conductive rails which are integrated in the module itself; in this way, the module may be cut to a desired length according to the application and usage needs, without relevant limitations as regards higher lengths: the electrical resistance of such electrically conductive rails may actually be lower than that of electrically conductive strips or lines, e.g. made of copper, which may be present e.g. on a flexible printed circuit,
single light radiation sources (e.g. small LED modules or the like) may be arranged practically at any position in a channel-shaped or U-shaped housing; this leads to the implementation of solutions with a “free” pitch of the light radiation sources, the possibility being given e.g. of changing said pitch along the lengthwise extension of the LED module,
   the portions of a LED module between two adjoining light radiation sources may exhibit high flexibility, which enables e.g. to bend the LED module practically in any direction,
   the LED module may be cut virtually at any position between two adjoining light radiation sources,
it is possible to use different light radiation sources with the same channel-shaped housing, thus reducing development costs and implementation times of new products,
it is possible to mix different types of light radiation sources on the same (e.g. LED) module,
the thermal behaviour is improved with respect to the modules employing a standard FPC circuit treated with a potting mass,
for specific applications it is possible to add e.g. three or more conductive rails, which leads to the achievement of a LED module having e.g. individually addressable sources, a tunable colour temperature and/or RGB modules, and so on,
the same channel-shaped housing with integrated conductive rails may be used for various supply voltages (e.g. 12 V, 24 V or 48 V), while preserving a satisfactory electrical insulation level also in the presence of a direct AC supply from the mains,
the manufacturing costs of LED modules may be decreased, e.g. thanks to the possibility of using standard rigid boards to implement the single light radiation sources,
the (e.g. IP degree) protection is favoured by the manufacturing process and by the use of connectors and end caps having IP sealing properties, similarly to what is currently used for protected and diffuse LED modules.

### BRIEF DESCRIPTION OF THE FIGURES

One or more embodiments will now be described, by way of non-limiting example only, with reference to the annexed Figures, wherein:

FIGS. 1 to 3 show housings for lighting devices according to one or more embodiments,

FIGS. 4 and 5 show possible usages of housings according to one or more embodiments,

FIGS. 6 and 7 exemplify the mounting of light radiation sources onto housings according to one or more embodiments,

FIGS. 8 and 9 exemplify the mounting of light radiation sources onto housings according to one or more embodiments,

FIGS. 10 and 11 exemplify the mounting of light radiation sources onto housings according to one or more embodiments, and

FIGS. 12 and 13 exemplify the mounting of light radiation sources onto housings according to one or more embodiments.

It will be appreciated that, for clarity and simplicity of illustration, the various Figures may not be drawn to the same scale.

### DETAILED DESCRIPTION

In the following description, various specific details are given to provide a thorough understanding of various exemplary embodiments of the present specification. The embodiments may be practiced without one or several specific details, or with other methods, components, materials, etc. In other instances, well-known structures, materials or operations are not shown or described in detail to avoid obscuring various aspects of the embodiments.

Reference throughout this specification to “one embodiment” or “an embodiment” means that a particular feature, structure, or characteristic described in connection with the embodiment is included in at least one embodiment. Thus, the possible appearances of the phrases “in one embodiment” or “in an embodiment” in various places throughout this specification are not necessarily all referring to the same embodiment. Furthermore, particular features, structures, or characteristics may be combined in any suitable manner in one or more embodiments.

The headings provided herein are for convenience only, and therefore do not interpret the extent of protection or scope of the embodiments.

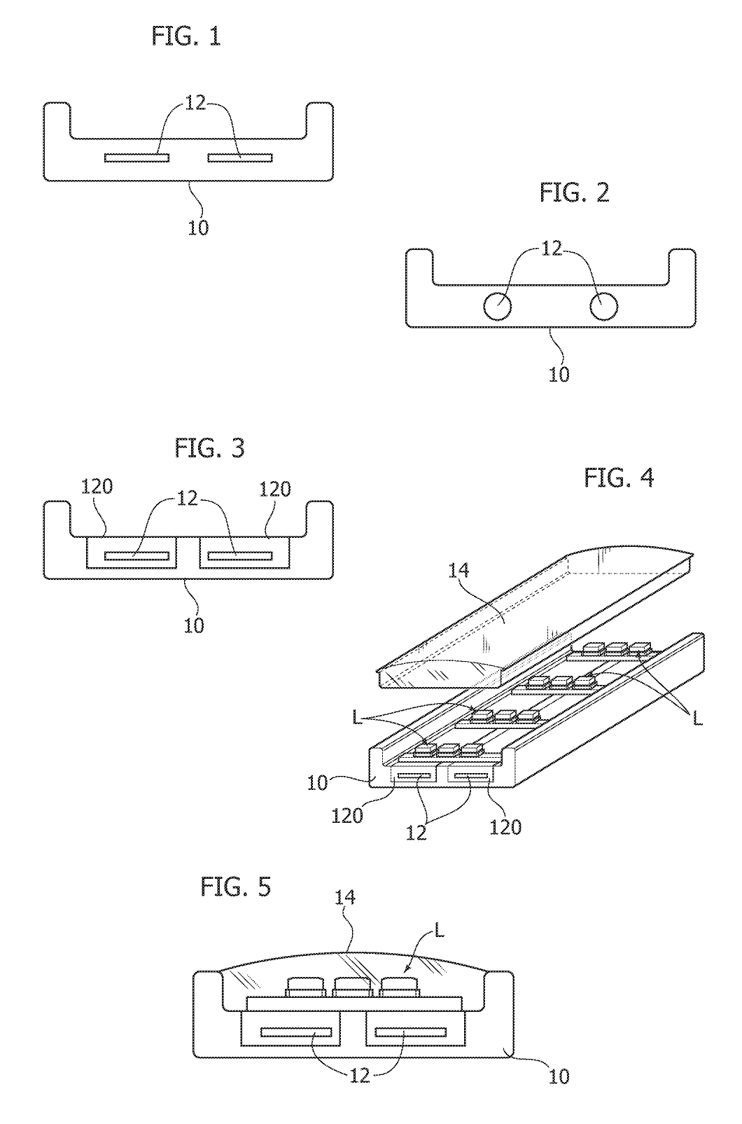

FIGS. 1 to 5 show features of one or more embodiments, adapted to integrate electrically conductive (e.g. metal) rails into the body of a housing 10 of a lighting device adapted to employ electrically-powered light radiation sources L, for example solid-state light radiation sources such as LED sources.

In this respect, it will be appreciated that one or more implementation features exemplified herein with reference to one of the annexed Figures may be transferred to embodiments shown in different Figures.

In one or more embodiments, housing 10 may be a channel-shaped housing, i.e. a housing of elongated shape (and virtually of indefinite length, and optionally adapted to be cut to length according to the application and usage needs) having a U-shaped cross section.

In one or more embodiments, housing 10 may include electrically insulating, optionally flexible material, such as a silicone polymer.

As better detailed in the following, in one or more embodiments one or more light radiation sources L may be arranged freely along the lengthwise extension of housing 10, virtually at any position.

In one or more embodiments, the light radiation source(s) L may include LED modules, e.g. according to the techniques known as Chip-on-Board (CoB) or Pin-Through-Hole.

In one or more embodiments, housing 10 may be provided, e.g. at the core or central wall thereof, with electrically conductive lines 12 adapted to have e.g. a flattened shape (see for example FIG. 1) or a circular section (see e.g. FIG. 2).

In both cases, the electrically conductive lines may either have a solid structure or include stranded wires.

In one or more embodiments, the electrically conductive lines 12 may be integrally embedded into the material of housing 10, or they may be embedded (as exemplified in FIG. 3) into masses of an electrically conductive material (e.g. a polymer) 120 which emerge at the surface of housing 10, e.g. at the bottom wall, within the channel shape or U shape of housing 10.

In one or more embodiments (and as further detailed in the following) the electrical contact between electrically conductive lines 12 and light radiation sources L may be established according to different solutions (sharp piercing contacts, fork-shaped contacts, electrically conductive glue drops, etc.).

In one or more embodiments, the number of electrically conductive lines 12 may be chosen at will. One or more embodiments, as exemplified in FIGS. 1 to 5, refer to possible solutions having two electrically conductive lines 12 adapted to act, e.g., as lines for distributing a supply voltage (e.g. a direct voltage) to light radiation sources L.

One or more embodiments may envisage a different number of lines 12, e.g. a higher number such as three lines 12 or more; this may be the case, for instance, if the light radiation sources require a control action (e.g. a dimming function) and/or a feedback function on the temperature reached by the sources in operation.

In one or more embodiments, the structure of the obtained lighting device (adapted to be included e.g. of a so-called flexible or “flex” LED module) may be rounded off with the provision of a potting mass 14 introduced into the cavity of the channel shape of housing 10.

Therefore, one or more embodiments may achieve (e.g. through a chemical adhesion to the polymeric material of profiled housing 10) a protection of device 10 against the penetration of foreign agents, e.g. an IP degree protection.

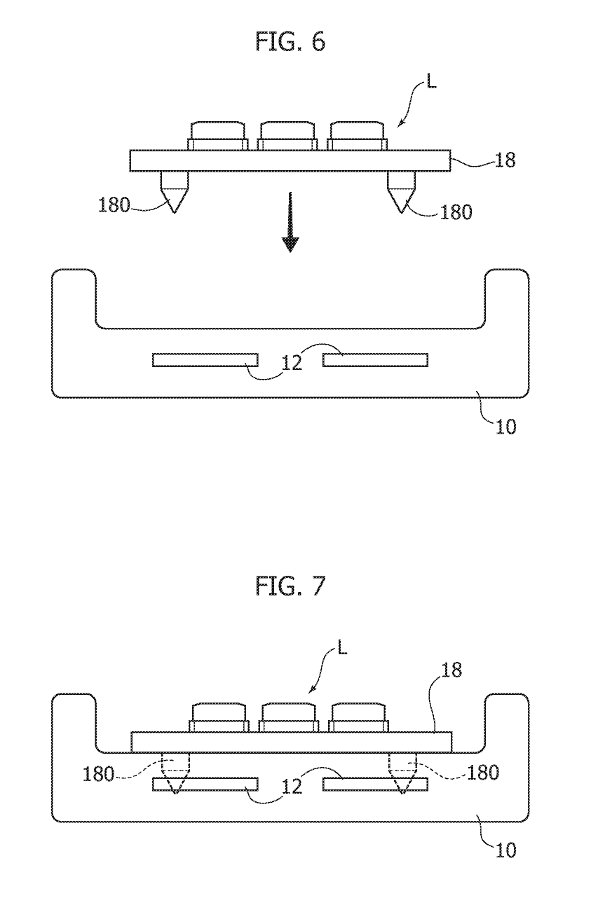

FIGS. 6 and 7 show the possibility of establishing the electrical contact between the light radiation source(s) L and the electrically conductive lines 12 by resorting, for mounting the light radiation source(s) L, to a structure including e.g. a support board 18 (substantially similar to a Printed Circuit Board, PCB) which hosts, e.g. on the face of board 18 opposite the face mounting the light radiation source(s) L, sharp electrical contacts 180.

In one or more embodiments, when the or each light radiation source L is inserted into the channel-shaped housing 10, contacts 180 (which, through electrically conductive lines provided in support 18, are connected to the light radiation source(s) L) may penetrate through the material (e.g. silicone) of housing 10, so as to establish a contact, optionally exerting a piercing action (see FIG. 7) on electrically conductive lines 12, which are exemplified herein as flattened rails.

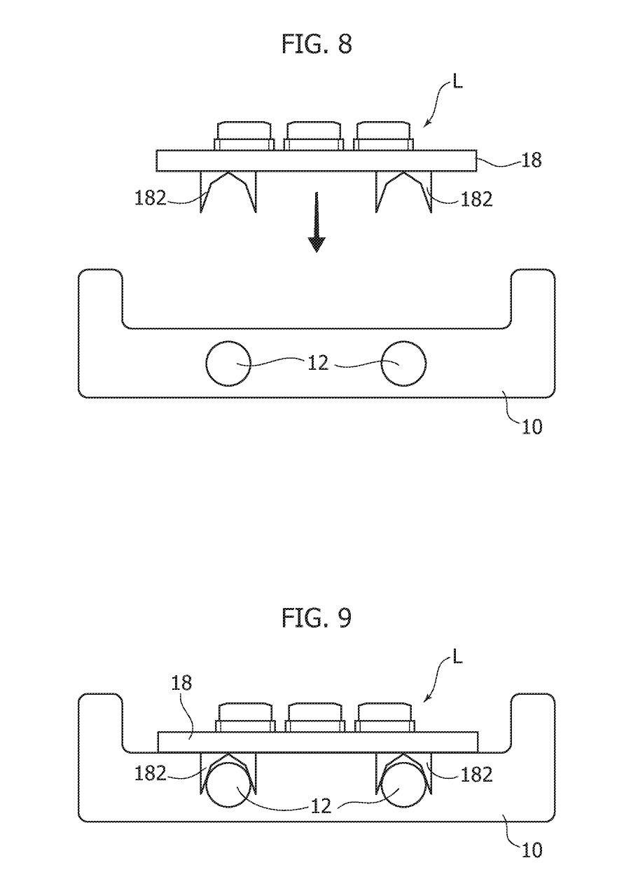

FIGS. 8 and 9 exemplify (according to solutions substantially similar to FIGS. 6 and 7) the possibility of providing the electrical contact between the light radiation source(s) L and the electrically conductive lines 12 by resorting to contacts 182 (which may be carried by board 18 which mounts sources L) having a general fork-like shape.

When the or each light radiation source L is inserted into the channel-shaped housing 10, the fork-shaped contacts 182 may penetrate into the material of housing 10 and are adapted, thanks to their fork-like shape, to “surround” the electrically conductive lines (see FIG. 9).

One or more embodiments, as exemplified in FIGS. 8 and 9, may make use of electrically conductive lines 12 having an at least approximately circular cross-section, adapted to be surrounded by the fork-like shape of contacts 182.

Once again it is to be highlighted that, irrespective of the implementation details (e.g. as regards the shape of the cross section) the electrically conductive lines 12 may be implemented either in solid form or as stranded conductors.

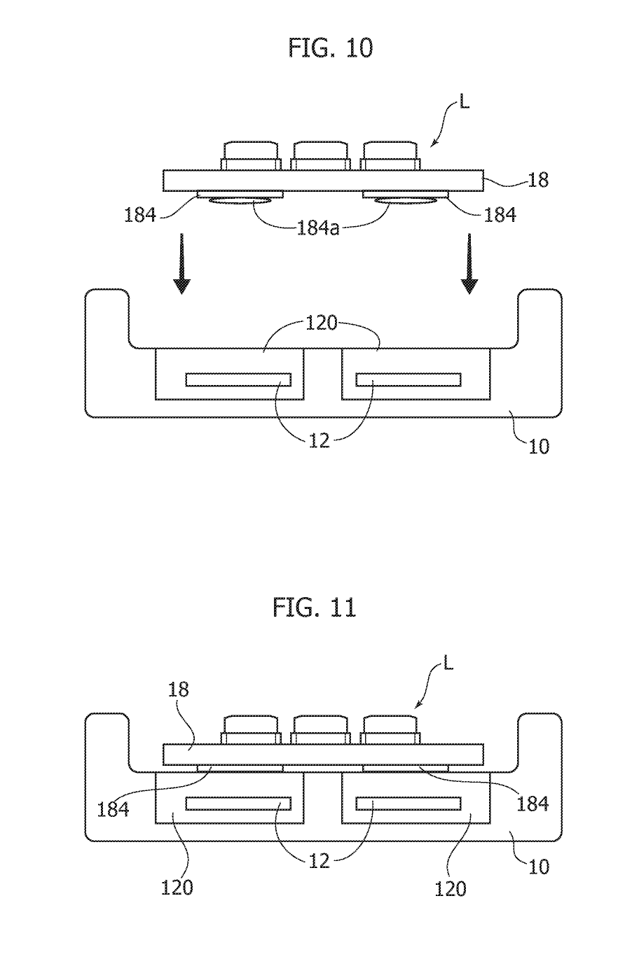

FIGS. 10 and 11 exemplify, once again in the same sequence as FIGS. 6 and 7 as well as 8 and 9, one or more embodiments wherein the electrically conductive lines 12 are embedded (optionally through a co-extrusion process) into electrically conductive masses (e.g. an electrically conductive polymeric material) extending around the electrically conductive lines 12.

Moreover, the electrically conductive masses 120 embedding lines 12 may emerge at the bottom or central wall of channel-shaped housing 10.

In this case, the electrical contact with the light radiation source(s) may be obtained via electrical contact lands 184 provided on board 18, e.g. on the face opposite the face which mounts light radiation source(s) L, with masses of electrically conductive (e.g. adhesive) material 184a located between the lands 184 and the electrically conductive masses 120.

Material 120 and adhesive 184 may contribute to impart the implemented electrical contact with an ohmic resistance higher than the ohmic resistance which may be obtained through e.g. metal contacts. The fact that such a connection originates a certain ohmic resistance (in series) may be considered negligible, because at any rate (e.g. in the case of adhesive layer 184a) it is a thin layer which is sandwiched between conductive materials having a rather large exposed surface.

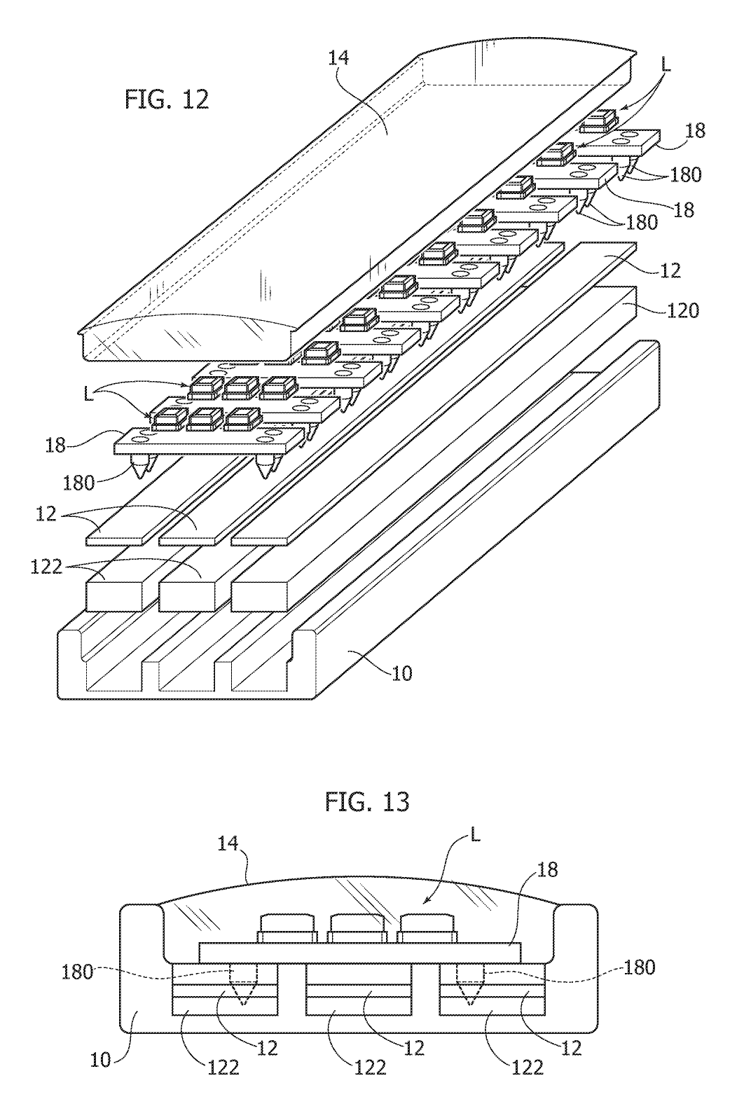

FIGS. 12 and 13 exemplify the possibility, already mentioned in the foregoing, of transferring one or more implementation features exemplified herein with reference to one of the annexed Figures to embodiments exemplified in different Figures, while highlighting the possibility of using any number of electrically conductive lines 12.

For example, FIGS. 12 and 13 refer to the possibility of using three electrically conductive lines 12, according to a solution which may be used e.g. in the production of lighting devices offering the possibility of varying the colour temperature of a light-coloured (e.g. “white”) lighting radiation, e.g. by implementing a colour regulating function on the radiation emitted by a system which includes single sources emitting radiations with different colours, e.g. according to an RGB pattern.

The use of a number N>3 of electrically conductive lines 12 leads e.g. to the implementation of a data transmission function to and from the single sources L, e.g. a function of individual selective addressing of each source L.

FIGS. 12 and 13 exemplify the possibility, in one or more embodiments, of embedding electrically conductive lines 12 into the channel-shaped body of housing 10, by associating electrically insulating masses 122 to the electrically conductive lines 12, e.g. by originating a sandwich structure which may be arranged in the channel-shaped cavities provided in housing 10, e.g. in the bottom or core wall thereof.

As exemplified in dashed lines in FIG. 13, the electrical contact between sources L and lines 12 may be implemented with contacts 180 which penetrate the insulating layer of the sandwich and reach the conductive layer (“rail”) 12.

This may take place according to different solutions for the various sources L. For example, FIG. 13 shows a source L electrically connected to the two “external” rails 12 among the three rails shown, while the central rail extends below said source and is therefore insulated, i.e. without electrical contact therewith.

Said central rail may on the other hand be electrically connected to another source L: in this way it is possible to selectively activate the various sources L according to the application needs.

Moreover, in one or more embodiments, one and the same channel-shaped housing with a plurality of integrated conductive rails may be used for various supply voltages (e.g. 12 V, 24 V or 48 V) while preserving a satisfactory electrical insulation.

One or more embodiments may therefore concern a housing (e.g. 10) for lighting devices, the housing including an electrically insulating channel-shaped elongated body, with a plurality of electrically conductive lines (e.g. 12) which extend along the length of said channel-shaped body, said electrically conductive lines being embedded in said channel-shaped body.

In one or more embodiments, said electrically conductive lines may extend in the central portion of said channel-shaped body.

In one or more embodiments, said electrically conductive lines may include electrically conductive lines of:
a flat shape, and/or
a circular shape.

In one or more embodiments, said electrically conductive lines may have:
a solid structure, or
a stranded structure.

In one or more embodiments, said electrically conductive lines may have an electrically conductive lining (e.g. 120) emerging at the surface of said electrically insulating channel-shaped body.

In one or more embodiments, a lighting device may include:
a housing according to one or more embodiments,
   at least one electrically-powered light radiation source module (e.g. L, 18) arranged in said housing, said module being provided with electrical contact formations (e.g. 180, 182, 184) with said electrically conductive lines.

In one or more embodiments, said electrical contact formations may include:
sharp contacts (e.g. 180) adapted to penetrate into said channel-shaped body for establishing a contact with said electrically conductive lines, and/or
fork-like contact formations (e.g. 182) adapted to penetrate into said channel-shaped body for establishing a contact with said electrically conductive lines, by being arranged astride said electrically conductive lines, and/or
   contact lands (e.g. 184) to make contact adhesion (e.g. 184a) with the electrically conductive linings of said electrically conductive lines emerging at the surface of said electrically insulating channel-shaped body.

One or more embodiments may include at least one sealing mass (e.g. 14) sealingly enclosing said at least one light radiation source module in said housing.

In one or more embodiments, said at least one light radiation source module may include a LED light radiation source.

In one or more embodiments, a method for making a lighting device may include:
providing a housing according to one or more embodiments,
   arranging in said housing at least one electrically-powered light radiation source module; said module being provided with electrical contact formations with said electrically conductive lines and optionally including a LED light radiation source.

Without prejudice to the basic principles, the details and the embodiments may vary, even appreciably, with respect to what has been described herein by way of non-limiting example only, without departing from the extent of protection.

The extent of protection is defined by the annexed claims.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A housing for lighting devices, the housing comprising an electrically insulating channel-shaped elongated body, with a plurality of electrically conductive lines which extend along a length of said channel-shaped body said electrically conductive lines embedded in said channel-shaped body.

2. The housing of claim 1, wherein said electrically conductive lines extend in a central portion of said channel-shaped body.

3. The housing of claim 1, wherein said electrically conductive lines comprise electrically conductive lines of:
a flat shape, and/or
a circular shape.

4. The housing of claim 1, wherein said electrically conductive lines have:
a solid structure, or
a stranded structure.

5. The housing of claim 1, wherein said electrically conductive lines have an electrically conductive lining emerging at a surface of said electrically insulating channel-shaped body.

6. A lighting device, comprising:
a housing, wherein the housing comprises an electrically insulating channel-shaped elongated body, with a plurality of electrically conductive lines which extend along a length of said channel-shaped body said electrically conductive,
at least one electrically-powered light radiation source module arranged in said housing, said module being provided with electrical contact formations with said electrically conductive lines.

7. The lighting device of claim 6, wherein said electrical contact formations comprise:
sharp contacts to penetrate into said channel-shaped body for making contact with said electrically conductive lines, and/or
fork-like contact formations to penetrate into said channel-shaped body for making contact with said electrically conductive lines by being arranged astride said electrically conductive lines, and/or
contact lands to make contact adhesion to electrically conductive linings of said electrically conductive lines emerging at a surface of said electrically insulating channel-shaped body.

8. The lighting device of claim 6, further comprising at least one sealing mass sealingly enclosing said at least one light radiation source module in said housing.

9. The lighting device of claim 6, wherein said at least one light radiation source module comprises a LED light radiation source.

10. A method for making a lighting device, the method comprising:
providing a housing, wherein the housing comprises an electrically insulating channel-shaped elongated body, with a plurality of electrically conductive lines which extend along a length of said channel-shaped body said electrically conductive, and
arranging in said housing at least one electrically-powered light radiation source module (L, 18); said module provided with electrical contact formations with said electrically conductive lines.

11. The method of claim 10,
wherein said module is provided with electrical contact formations with said electrically conductive lines and comprising a LED radiation source.
